(19) United States
(12) Patent Application Publication
(10) Pub. No.: US 2025/0121552 A1
(43) Pub. Date: Apr. 17, 2025

(54) PIPE SETTING DEVICE

(71) Applicant: Yehuda SCHIFFER, Cedarhurst, NY (US)

(72) Inventor: Yehuda SCHIFFER, Cedarhurst, NY (US)

(21) Appl. No.: 18/487,823

(22) Filed: Oct. 16, 2023

(51) Int. Cl. B29C 53/08; B29C 53/84

(52) U.S. Cl. CPC B29C 53/083; B29C 53/84

(57) ABSTRACT

There is disclosed a first embodiment which is a device for molding pipes around unusual surfaces comprising at least one block, having at least one channel for receiving a pipe, a hinge, and a linkage coupled to the hinge. The block comprises at least one side wall extending above the channel on the block. The channel comprises a concave surface which is rounded, wherein the channel is indented into the block. The device can include a plurality of blocks coupled together via a plurality of linkages so that the device can move in a serpentine manner and extend flexibly over an uneven wall.

### BACKGROUND OF THE INVENTION

Pipes such as PVC pipes or even metal pipes can sometimes be troublesome to set on a wall that has an uneven surface. When a plumber or an electrician tries to set a pipe such as a metal pipe or a PVC (Polyvinyl Chloride) pipe on a wall if the pipe is straight and is stiff, it will not adhere to an uneven wall. Therefore, sometimes an electrician or a plumber may try to heat and then mold the pipe on a wall. However, setting the pipe on a wall can be quite tricky as the heating of the pipe can burn a user's hand or the heated pipe can be cumbersome with respect to an uneven wall. Therefore, there is a need to set a pipe on an uneven wall in an orderly and save manner so that the pipe can be heated and set either permanently or semi permanently on a wall without damaging a user's hands.

### SUMMARY

There is disclosed a first embodiment which is a device for molding pipes around unusual surfaces comprising at least one block, having at least one channel for receiving a pipe, a hinge, and a linkage coupled to the hinge. The block comprises at least one side wall extending above the channel on the block. The channel comprises a concave surface which is rounded, wherein the channel is indented into the block. The device can include a plurality of blocks coupled together via a plurality of linkages so that the device can move in a serpentine manner and extend flexibly over an uneven wall.

There is also a process for using the device. The process starts wherein in step 1 the user identifies the surface to apply the device. Next, in step 2 the user wraps the guide around the surface to estimate the shape that the pipe will have to assume. Next, the user can gather the pipe and heat the pipe so that it is bendable. Next, the user can use the device to press the pipe against the wall so that the pipe assumes the shape around the wall. Next, the user can hold the device while pressing the pipe against the wall, so that as the pipe cools, it ultimately forms the desired shape against the wall. Next, the user can secure the bent or shaped pipe against the wall in step 7. Next, if the pipe is an electrical pipe, the user can insert electrical wires into the pipe so that the wires are protected and shielded around multiple obstructions around the wall.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a perspective view of the first embodiment of a pipe setting device;

FIG. 2A is a top view of a block of a portion of the pipe setting device;

FIG. 2B is a side view of a block of a portion of the pipe setting device;

FIG. 2C is an end view of a block of a portion of a pipe setting device;

FIG. 2D is an end view of the linkage and block being positioned to a pipe;

FIG. 3A is a perspective view of a linking of a pipe setting device;

FIG. 3B is a top view of a lock washer which has teeth meshing together;

FIG. 4 is a perspective view of the pipe setting device shown in FIG. 1;

FIG. 5 is a view of the pipe setting device in a bent manner;

FIG. 6 is another view of the pipe setting device in a bent manner;

FIG. 7 is a flow chart of the process for setting pipes on a wall;

FIG. 8 is a view of the pipe setting device setting a pipe on a wall around an obstruction;

FIG. 9A shows an end view of another embodiment of the invention; and

FIG. 9B shows a side view of another embodiment of the invention.

### DETAILED DESCRIPTION

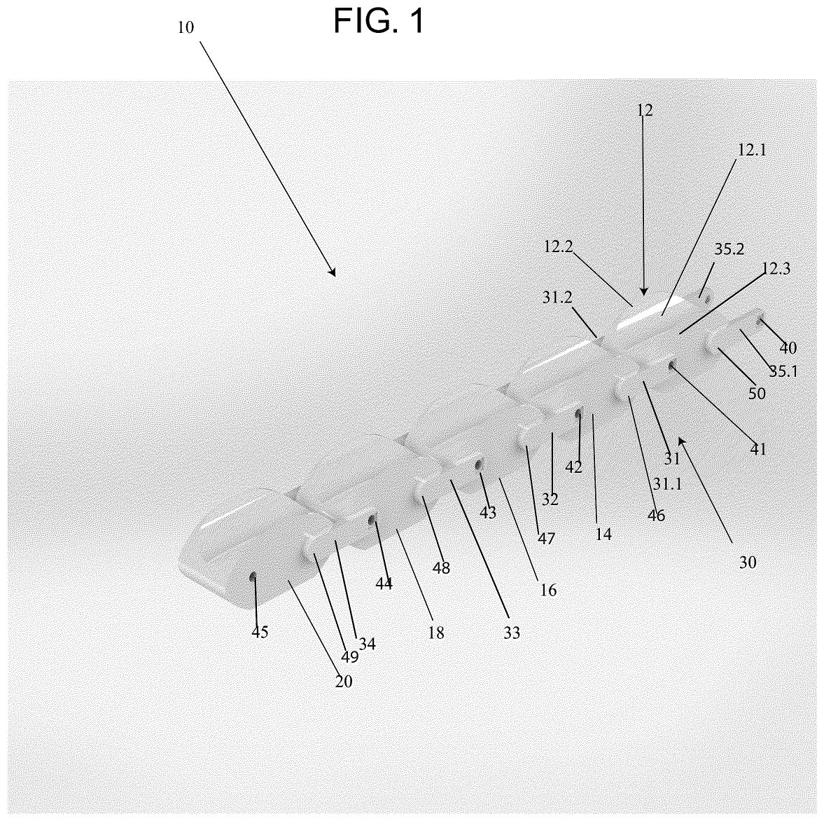

FIG. 1 is a perspective view of the first embodiment of a pipe setting device 10 which includes a plurality of blocks such as blocks 12, 14, 16, 18 and 20. Each of the blocks includes a guide channel such as guide channel 12.1 which is concave, and side walls such as side walls 12.2 and 12.3 which rise up above channel 12.1 In addition each block such as block 12 includes a bull nose end such as bull nose 12.4.

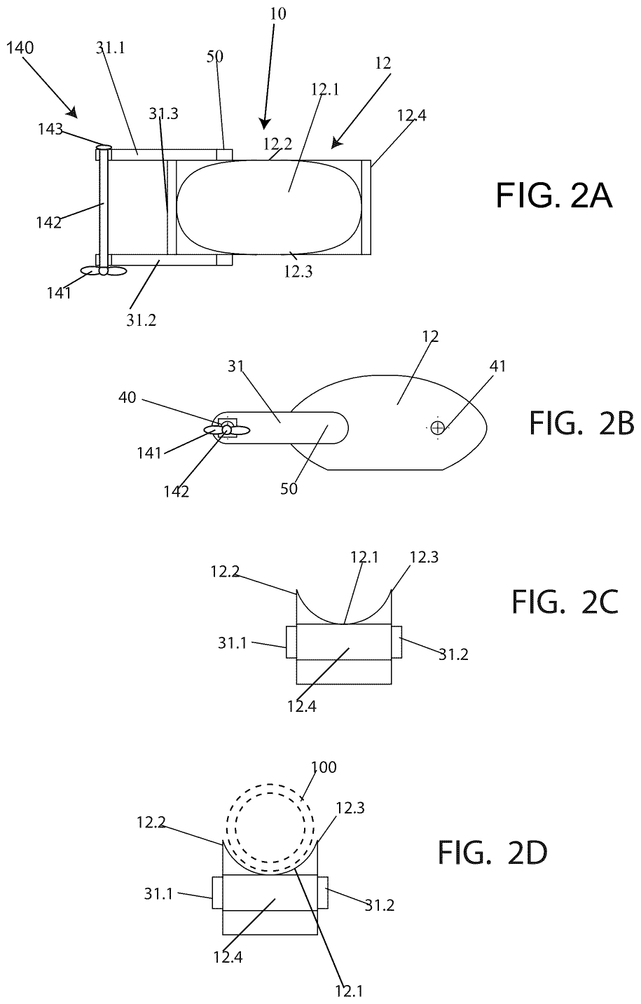

Coupled to each block are linkages such as linkages 30. These linkages include a first linkage 31, a second linkage 32, a third linkage 33, a fourth linkage 34, and a fifth linkage 35. While five particular linkages are shown additional or fewer blocks or linkages can be used as well. Each of the linkages such as linkage 31 includes a first linkage 31.1 and a second linkage 31.2 (See Also FIG. 2A). There is also a cross bar 31.3 which bridges the first linkage 31.1 and the second linkage 31.2. There are also linkage axles coupling the linkages to the respective blocks. For example, there is a linkage axle 40, 41, 42, 43, 44, 45, 46, 47, 48, 49, and 50. Each block has two axles, and each joint is formed by a set of linkages with axles or hinges at each end.

For example, between block 12, and 14 there is a linkage 31 with hinges or axles 41 and 46 on opposite ends of linkage 31 allowing for a flexible coupling between blocks 12 and 14. In addition, between block 14 and 16 there is a linkage 32 which has axles 42 and 47 on each end of the linkage coupling blocks 14 and 16 together in a flexible connection. Blocks 16 and 18 are coupled together with linkage 33, having hinges or axles 43 and 48 on each end of linkage 33. Furthermore, blocks 18 and 20 are coupled together via linkage 34 having hinges or axles 44 and 49 on each end of the linkage 34. Axle 45 is shown as an empty hole which can be filled with an axle coupling to an additional linkage if the user desires.

Thus, the device is formed as a flexible linkage which can be bent and molded into different shapes so that the blocks are rotatably coupled together so that the blocks can move relative each other in a serpentine manner, and the blocks can be bent around an obstruction on a wall so that it allows for the bending and molding of pipe such as PVC pipe on the device.

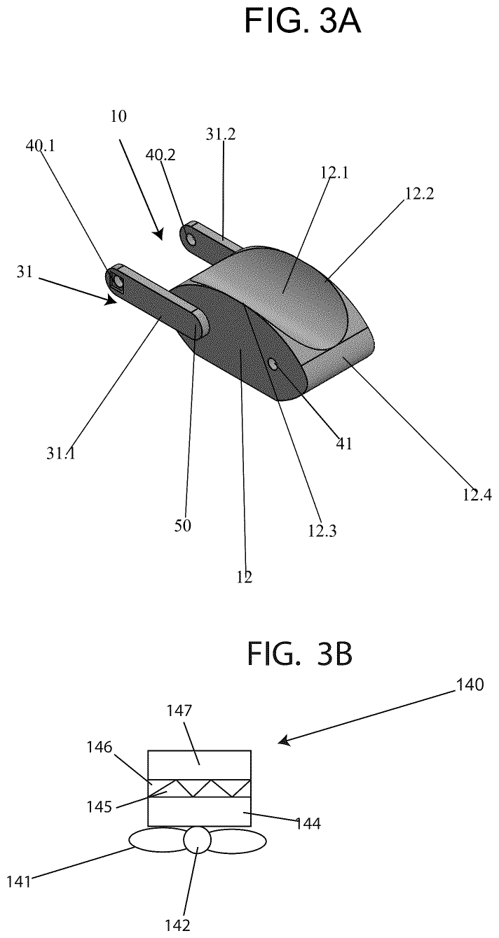

FIG. 2A is a top view of a linkage of a portion of the pipe setting device. In this view there is shown block 12 having guide channel 12.1 as well as side walls 12.2, and 12.3. There is also bull nose front section 12.4. There is also shown a first side linkage 31.1 and a second side linkage 31.2 as well as a cross bar 31.3. Axle 41 is also shown which allows the linkage 31 to rotate about the axle 50. In this view there is shown a lock washer 140 having a bolt 142 with a head 143 at one end and a wing nut 141 at the opposite end. The lock washer 140 is configured to lock the linkage in a certain angle via teeth (See FIG. 3B) formed in the lock washer such that when the lock washer is tightened down it locks a first set of teeth against a second set of teeth to lock the linkage at a pre-set angle. This allows the device to be formed and extending at certain angles so that when a pipe is softened or melted it can be placed in the device and molded to the shape of the device.

FIG. 2B shows a side view of block 12, which shows linkage 31 as well as axle 40 and axle 50 coupled to block 12. There is also shown axle 41 as well. Axle 41 is configured to receive a bolt such as bolt 142 and then be secured in place at a pre-set angle via another lock washer such as lock washer 141.

FIG. 2C is an end view of a linkage of a portion of a pipe setting device, in this view there is shown block 12 having a groove or guide channel 12.1 and side walls 12.2, and 12.3. There are shown linkages 31.1 and 31.2 as well as bull nose 12.4.

FIG. 2D shows an end view of block 12, wherein disposed adjacent to the guide channel 12.1 there is a pipe 100 adjacent to the side walls 12.2 and 12.3. This view also shows linkages 31.1 and 31.2 as well as bull nose 12.4. As shown, pipe 100 sits in channel 12.1 so that approximately or substantially half of the pipe is surrounded by the channel, so that the pipe is supported in at least three different dimensions. The term approximately or substantially can mean anywhere from 20 percent of the outer diameter of the pipe to 40 percent, 50 percent, or even more than 50 percent of the diameter of the pipe.

FIG. 3A is a perspective view of a linking of a pipe setting device. This view shows block 12, as well as the groove or guide channel 12.1, the side walls 12.2 and 12.3, linkages 31.2 and 31.2, axle 50 which allows linkages 31.1 and 31.2 to rotate. There is also axle 41 on the opposite end of block 12 from axle 50. There are also shown axle connections 40.1 and 40.2. Bull nose 12.4 is also shown as well.

FIG. 3B is a top view of a lock washer 140 which has teeth meshing together, for example, there is wing nut 141 coupled to bolt 142. Wing nut 141 is coupled to an adjacent block 144 having a first set of teeth 145. A second set of complementary teeth 146 mesh with first set of teeth 145. Second set of teeth 146 are coupled to block 147. Block 147 then locks with block 144 when a wing nut 141 is screwed down on bolt 142 to mesh teeth 145 with teeth 146 thereby creating a locked state of lock washer 140. This then fixes the block in a set position so that a pipe such as a PVC pipe can then be molded into a desired shape.

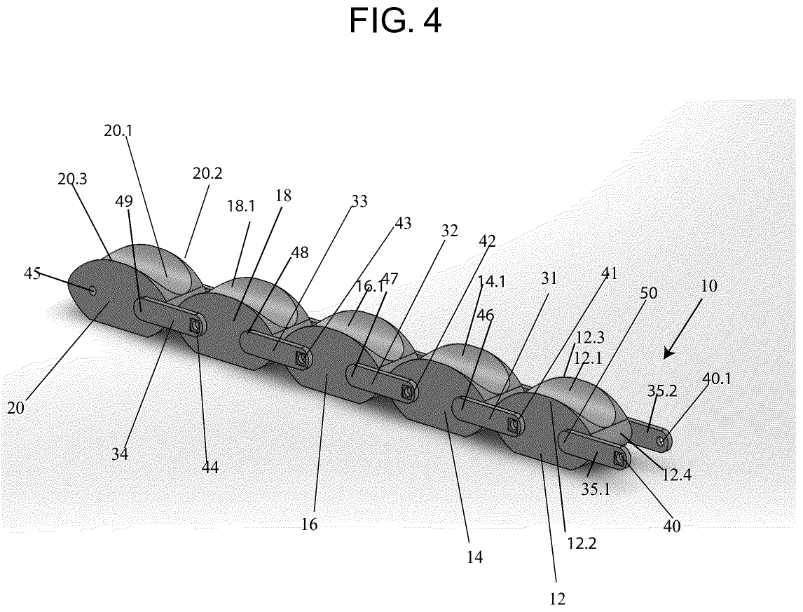

FIG. 4 is a perspective view of the pipe setting device shown in FIG. 1. For example, this view shows blocks 12, 14, 16, 18, and 20. Block 12 has linkages 35.1 and 35.2 coupled to block 12 via axle 50. Block 12 includes groove 12.1 and side walls 12.2 and 12.3. Each of the other blocks include grooves or channels as well as side walls wherein these grooves or channels and side walls are for guiding a pipe. Each of the blocks includes guide channels such that block 14 includes guide channel 14.1, block 16 includes guide channel 16.1, block 18, includes guide channel 18.1, while block 20 includes guide channel 18.1. and block 20 includes guide channel 20.1. Each of the guide channels includes side walls as well. A plurality of linkages including linkage 31, 32, 33, 34 are shown coupling the different blocks together through axles 50, 41, 46, 42, 47, 43, 48, 44, and 49 which allow the blocks to rotate and move freely to allow for the pressing in or clamping of a pipe.

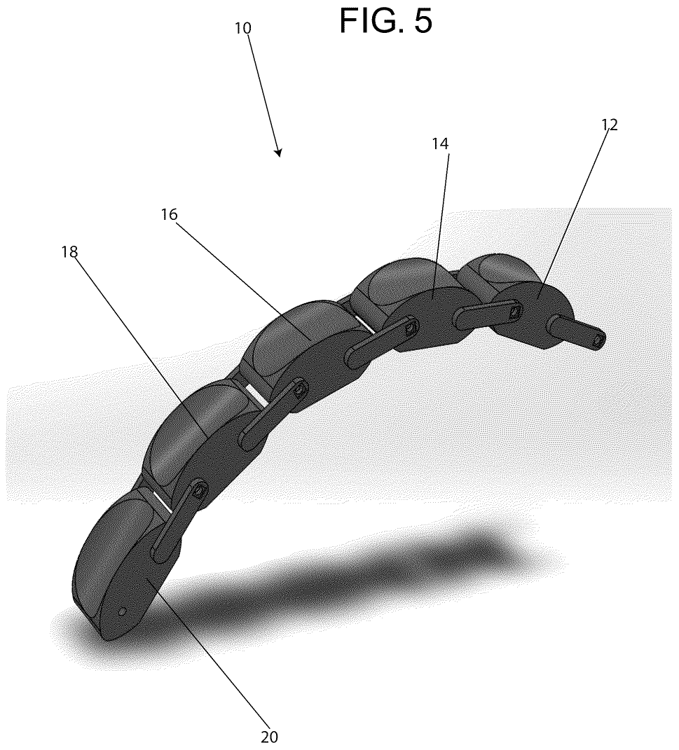

FIG. 5 is a view of the pipe setting device in a bent manner, this view shows the blocks 12, 14, 16, 18 and 20 bent in a circular manner via the different axles and linkages disclosed above. This bent form allows for the bending of a melted PVC pipe which has been heated to a temperature to bend the pipe around an obstacle on a wall.

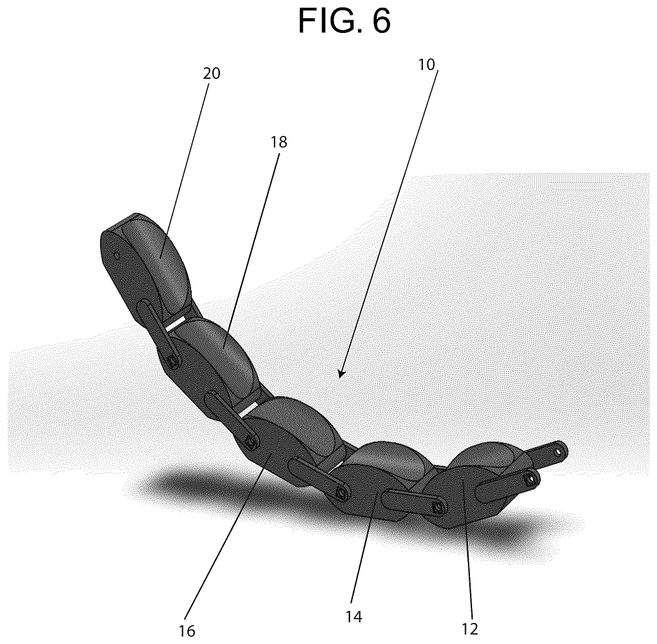

FIG. 6 is another view of the pipe setting device in a bent manner wherein there are shown blocks 20, 18, 16, 14, and 12 forming the device 10. This view shows that the blocks are configured to be molded in a bent manner around an obstruction.

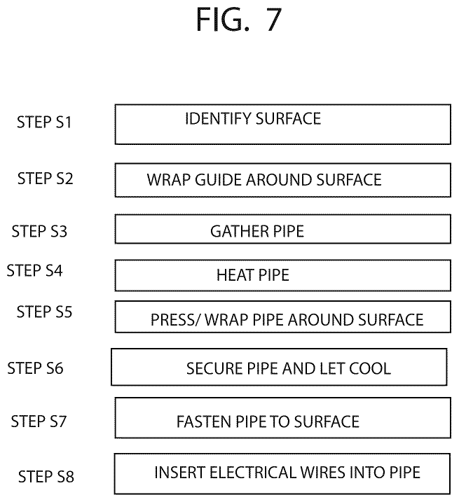

FIG. 7 is a flow chart of the process for setting pipes on a wall. For example, the process starts wherein the user identifies a surface on which to mount a pipe in step S1. Next, in step S2, the user wraps the guide such as guide device 10 around the surface on the wall. Next, in step S3 the user can gather a pipe and then in step S4 heat the pipe. Next, in step S5, the user can press or wrap the pipe around a pre-defined surface. Next, in step S6, the user can secure the pipe and let it cool to form the shape. Next, in step S7 the user can fasten the pipe to a surface using brackets or any other suitable material. Next, in step S8 the user can insert electrical wires into the pipe to allow for the passage of the wires in the pipe.

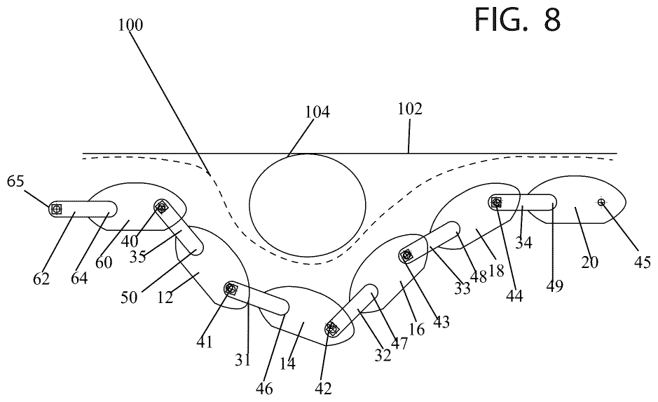

FIG. 8 is another view of a wall 102 having an obstruction 104 which then forces a pipe such as pipe 100 to be bent around the wall. Device 10 is shown having multiple blocks 60, 12, 14, 16, 18, and 20 positioned around the wall and the obstruction. The pipe such as pipe 100 sits within the blocks in channel 12.1 (See FIG. 2D). such that when device 10 is pressed against the heated pipe it helps mold the pipe around the obstruction. As described above there are also shown axles 40, 41, 42, 43, 44, 45, 46, 47, 48, 49, 50, 64, and 65, as well as linkages 31, 32, 33, 34, 35, and 62. Thus, the device 10 can be moved in a serpentine manner around the obstruction 104 to mold the pipe so that it can be coupled to the wall.

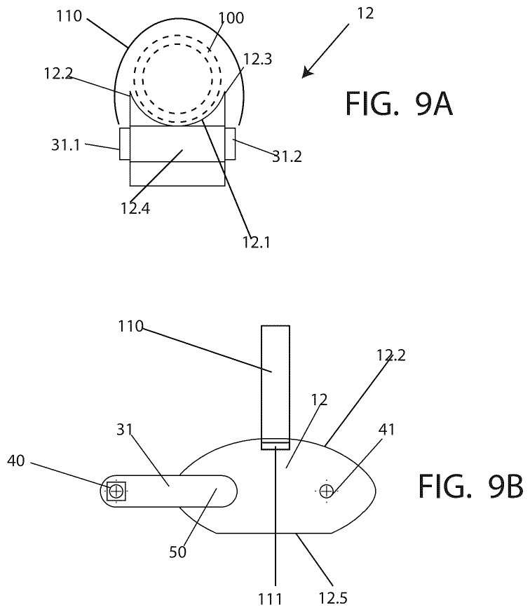

FIG. 9A shows a side view of block 12 having a bull nose 12.4, side linkages 31.1 and 31.2 side walls 12.2 and 12.3, as well as a channel or groove 12.1 for fitting a pipe 100. There is also shown a strap 110 which is coupled to block 12 via a connection joint 111 formed in both side walls 12.2, and 12.3.

FIG. 9B shows a side view of block 12 which has strap 110, coupled via connection joint 111, wherein block 12 includes axles 40, 41, and 50 and linkage 31. Thus, with this embodiment, the device can be pressed such that bottom side 12.5 is pressed against a wall such that the strap then allows for pulling of the pipe when the blocks are pressed against the wall thereby assisting in the formation of the pipe around an obstruction.

Accordingly, while at least one embodiment of the present invention have been shown and described, it is to be understood that many changes and modifications may be made thereunto without departing from the spirit and scope of the invention as defined in the appended claims.

What is claimed is:

1. A device for molding pipes around unusual surfaces comprising:
at least one block, said at least one block having at least one channel for receiving a pipe;
at least one hinge; and
at least one linkage coupled to said at least one hinge.

2. The device as in claim 1, wherein said at least one block comprises at least one side wall extending above said at least one channel on said block.

3. The device as in claim 2, wherein said at least one side wall comprises at least two side walls extending on opposite sides of said at least one channel.

4. The device as in claim 1, wherein said at least one channel comprises a concave surface which is rounded.

5. The device as in claim 1, wherein said at least one channel is indented into the block.

6. The device as in claim 1, wherein said at least one block comprises a plurality of blocks coupled together via said at least one linkage.

7. The device as in claim 6, wherein said at least one linkage comprises a plurality of linkages, wherein said plurality of linkages are for coupling a plurality of blocks together such that said plurality of blocks are rotatable coupled to each other.

8. The device as in claim 1, further comprising a strap, said strap being coupled to at least one block, wherein said strap is configured to wrap around a pipe.

9. The device as in claim 1, wherein said at least one block includes a plurality of side walls surrounding said channel.

10. The device as in claim 9, further comprising a strap, wherein said strap is coupled to said side walls of said block, said strap being configured to wrap around a pipe to couple the pipe to the block.

11. The device as in claim 1, further comprising a lock, coupled to said at least one hinge, wherein said lock is configured to lock said hinge in place.

12. The device as in claim 11, wherein said lock is in the form of a lock washer.

13. The device as in claim 11, wherein said lock washer has a plurality of teeth, with a first set of teeth being configured to mesh with a second set of teeth to lock the lock washer in place thereby preventing angular movement of said hinge.

14. A method for setting a pipe on a surface comprising the steps of:
identifying a surface to couple a pipe thereon;
placing a guide on the surface;
locking at least two blocks of the guide with respect to each other to create a pre-set shape of the guide;
gathering a pipe section;
heating the pipe;
coupling the heated pipe with the guide to form a pre-set shape for the pipe; and
allowing the pipe to cool to solidify in shape.

15. The method as in claim 14, further comprising the step of fastening the pipe to the identified surface.

16. The method as in claim 14, wherein the step of coupling the guide to the pipe includes pressing a bottom surface of the guide so that a guide channel on a block of the guide contacts the pipe to press the pipe onto the identified surface.

17. The method as in claim 16, wherein the step of heating the pipe comprises heating the pipe to a temperature to permit elastic deformation.

18. The method as in claim 17, further comprising inserting electrical wires into the cooled pipe so that the electrical wires are shielded.

19. The method as in claim 14, wherein said step of locking comprises locking at least one lock washer in place to prevent angular movement of said hinge, to thereby lock two blocks adjacent to each other at a pre-set angle.
